(19) United States
(12) Patent Application Publication
(10) Pub. No.: US 2015/0336167 A1
(43) Pub. Date: Nov. 26, 2015

(54) A METHOD OF FORMING A COMPONENT COMPRISING A SLEEVE MEMBER FORMED FROM A METAL MATRIX COMPOSITE

(71) Applicant: JAGUAR LAND ROVER LIMITED, Whitley, Coventry Warwickshire (GB)

(72) Inventors: Mike SHERGOLD, Warwick, Warwickshire (GB); David JAMESON, Warwick, Warwickshire (GB); Neil STEVENS, Northamptonshire (GB)

(21) Appl. No.: 14/654,519

(22) PCT Filed: Dec. 19, 2013
(86) PCT No.: PCT/EP2013/077519

§ 371 Date: Jun. 20, 2015

(30) Foreign Application Priority Data
Dec. 21, 2012 (GB) 1223198.1

(51) Int. Cl. B22D 19/02; B60G 7/00; B32B 15/01; B22D 21/00

(52) U.S. Cl. CPC B22D 19/02; B22D 21/007; B60G 7/001; B32B 15/016

(57) ABSTRACT

Embodiments of the present invention provide a method of forming a component comprising; providing a sleeve member formed from a metal matrix, composite material; and casting a cast portion of the component whereby at feast a portion of the cast portion Is provided within the sleeve member. Embodiments of the invention have the advantage that a component of increased stiffness may be fabricated compared with a cast component not comprising the sleeve member. The component may be formed to he of greater stiffness and reduced weight compared with a component of comparable strength and stiffness formed from a material such as steel.

### TECHNICAL FIELD

The present invention relates to a sleeve member and method of casting. Aspects of the invention relate to castings and to a method of casting a component.

### BACKGROUND

It is known to provide a cast aluminium component by casting molten aluminium into a mould. Aluminium and other relatively light metals such as aluminium alloy, magnesium or magnesium alloy may be used instead of heavier materials such as steel in order to reduce a weight of a component. This assists a manufacturer of a multi-component product such as a motor vehicle to control a weight of the product. However, aluminium has a relatively low Young's modulus (around 70 GPa). If a light but stiff component is required to be formed from aluminium, it is typically necessary to use more material than would otherwise be required of a part made from a stiffer material such as steel (having a Young's modulus of around 207 GPa). The extra material is normally distributed so as to increase the second moment of area of the component. Thus the geometry of the component is adjusted to increase stiffness of the component, for example bending and/or torsional stiffness or rigidity. In some applications, the available space into which a component must fit may be limited, requiring a stiffer material such as steel to be used in order to meet the required stiffness specification of the component. The use of steel however results in an increase in the weight of the component and is highly undesirable in some applications.

### SUMMARY OF THE INVENTION

Embodiments of the invention may be understood with reference to the appended claims.

Aspects of the present invention provide a method, a component, a system, a vehicle, an aircraft and a vessel.

In one aspect of the invention for which protection Is sought there is provided a method of forming a component comprising:
providing a sleeve member formed from a metal matrix composite material; and
casting a cast portion of the component whereby at least a portion of the cast portion is cast within the sleeve member.

It is to be understood that by reference to the cast portion being provided within the sleeve member is meant that the cast portion is provided within a bore of the sleeve member.

Embodiments of the invention have the advantage that a component of Increased stiffness may be fabricated compared with a cast component not comprising the sleeve member. The component may be formed to be of greater stiffness and reduced weight compared with a component of comparable strength and stiffness formed from a material such as steel.

In some embodiments a sleeve member may be placed in a mould for casting without requiring support whilst in the mould.

Some embodiments of the invention have the advantage bending and/or torsional stiffness or rigidity may be increased relatively to a component not having the sleeve member. Some embodiments allow a component of comparable stiffness to know components to be made more compact and/or lighter.

The component may be substantially elongate in shape. The component may be subject to one or more bending stresses in use.

The method may comprise casting the cast portion of the component such that the sleeve member defines at least a portion of an outer surface of the component.

The method may comprise forming the component whereby the sleeve member defines a conduit through which molten metal may flow to fill the sleeve member, the method comprising at least partially filling the sleeve member with molten metal.

Advantageously the method may comprise substantially filling the sleeve member with molten metal.

The method may comprise providing a substantially blind sleeve member having a single opening for molten metal to flow therein.

The method may comprise providing a sleeve member having a plurality of openings formed therein for molten metal to flow therethrough.

Advantageously the method may comprise causing molten metal to flow through the sleeve member to fill the sleeve member and allowing the molten metal to coot whereby respective portions of the cast portion of the component project from the sleeve member through respective openings defined by the sleeve member.

The step of providing a sleeve member formed from a metal matrix composite material may comprise providing a sleeve member formed from an aluminium matrix composite (AMC) material.

Advantageously the cast portion may be formed from a molten material comprising aluminium.

The molten material may be one selected from amongst aluminium and an aluminium alloy.

The method may comprise forming the component to be an automotive or aerospace component.

The method may comprise forming the component whereby the component is a component of a suspension system.

The component may be any suitable component of a suspension system such as a suspension arm, a linkage or any other suitable component.

Advantageously the metal matrix composite material may comprise alumina and at least one metal providing a matrix in which the alumina is embedded.

Advantageously the method may comprise placing the sleeve member in a mould; and introducing molten metal Into the mould.

In a further aspect of the invention for which protection is sought there is provided a component comprising a sleeve member, the sleeve member comprising a metal matrix composite material, the component comprising a cast portion wherein at least a portion of the cast portion is provided within the sleeve member.

The cast portion is advantageously formed to contact the sleeve member, optionally substantially the whole of an internal surface of the sleeve member is in contact with the sleeve member.

Advantageously the metal matrix composite material of the sleeve member may comprise an aluminium matrix composite material.

The metal matrix composite material may comprise alumina and at least one metal providing a matrix in which the alumina is embedded, optionally the at least one metal comprises aluminium, optionally the at least one metal consists essentially of aluminium.

The cast portion of the component may comprise one selected from amongst aluminium and an aluminium alloy.

The component may be a vehicle suspension component.

In a further aspect of the invention for which protection is sought there is provided a vehicle suspension system comprising a component according to the preceding aspect.

In a still further aspect of the invention for which protection is sought there is provided a motor vehicle, aircraft or vessel comprising a component according to a preceding aspect.

In a further aspect of the invention for which protection is sought there is provided a component comprising a sleeve member, the sleeve member comprising a metal matrix composite material, the component comprising a cast portion wherein at least a portion of the cast portion is provided within the sleeve member.

Within the scope of this application if is expressly intended that the various aspects, embodiments, examples and alternatives set out in the preceding paragraphs, in the claims and/or in the following description and drawings, and in particular the individual features thereof, may be taken independently or in any combination. Features described with reference to one embodiment are applicable to all embodiments, unless such features are incompatible.

For the avoidance of doubt, it is to be understood that features described with respect to one aspect of the invention may be included within any other aspect of the invention, alone or in appropriate combination with one or more other features.

Within the scope of this application it is expressly intended that the various aspects, embodiments, examples and alternatives set out in the preceding paragraphs, in the claims and/or in the following description and drawings, and in particular the individual features thereof, may be taken independently or in any combination. Features described with reference to one embodiment are applicable to all embodiments, unless such features are incompatible.

### BRIEF DESCRIPTION OF THE DRAWINGS

One or more embodiments of the invention will now be described, by way of example only, with reference to the accompanying figures in which:

FIG. 1 shows a known component of a motor vehicle suspension system formed from a cast aluminium alloy;

FIG. 2 shows a component of a motor vehicle suspension system according to an embodiment of the present invention; and

FIG. 3 shows a cross section through the A-A plane of the component of FIG. 2.

### DETAILED DESCRIPTION

Embodiments of the present invention are directed to providing an improved component formed in a casting operation.

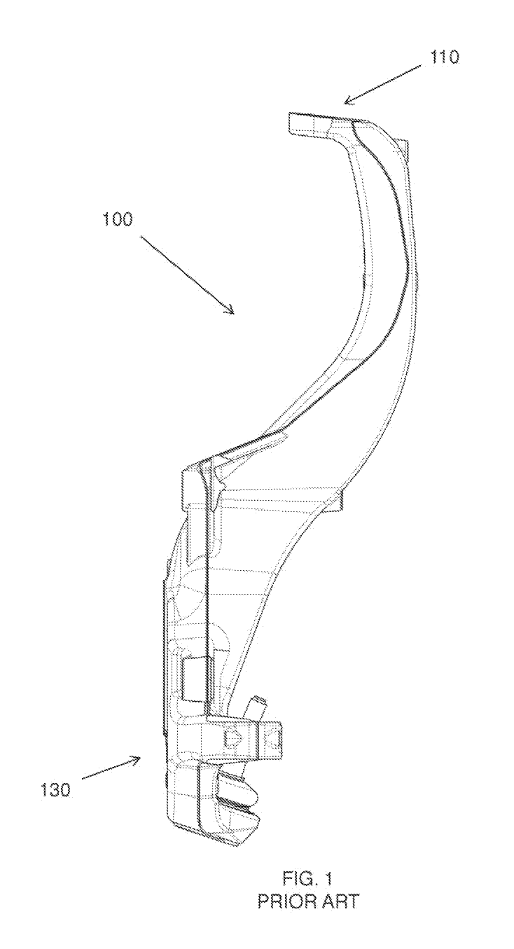

FIG. 1 shows a known component 100 of a motor vehicle suspension system formed by casting an aluminium alloy In a mould. The component forms a suspension arm of the suspension system and is of a substantially hooked shape. The component 100 has a first mounting portion 110 formed at a first end thereof and a second mounting portion 130 formed at a second end thereof opposite the first end. It is to be understood that if it is required to increase a strength and/or stiffness of the component 100, the conventional approach would be to increase a thickness of the component at one or more locations thereof, or to form the component from a different material such as steel. Each of these options may be undesirable. For example, there may be insufficient available packaging space to allow the component to be made from the same material but of thicker proportions. Similarly, it may be undesirable to employ a different material such as steel due to increased weight of the resulting component, and problems associated with corrosion in service.

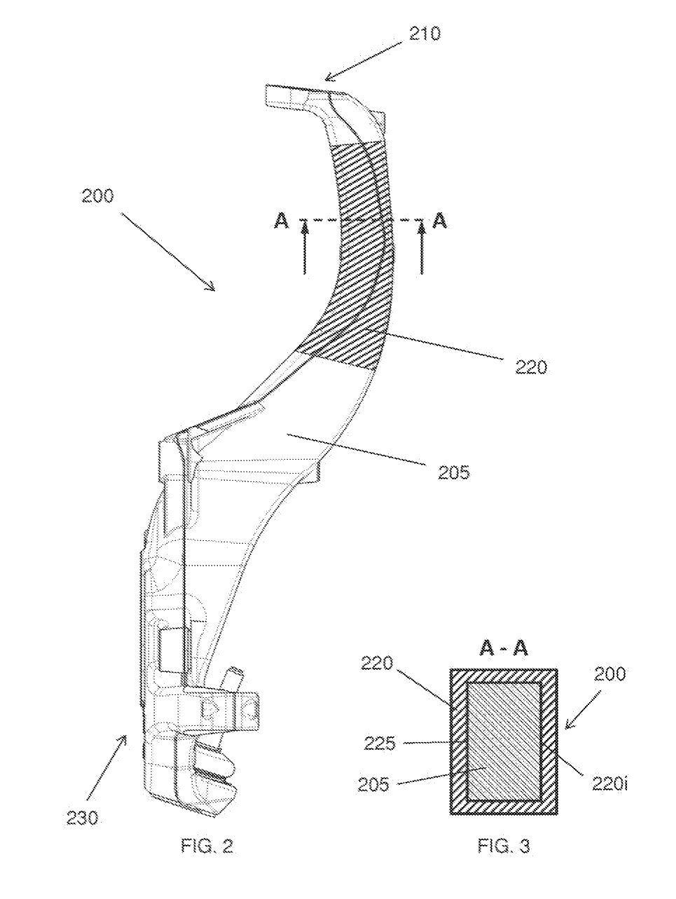

FIG. 2 shows a component 200 according to an embodiment of the present invention having a similar size to the known component of FIG. 1 but having a substantially increased stiffness. Like features of the component of FIG. 2 to the component of FIG. 1 are shown with like reference signs incremented by 100.

The component 200 comprises a sleeve member 220 formed from an aluminium matrix composite material (AMC). In the present embodiment the AMC composes alumina fibres that have been bent to form the sleeve shape. The fibres have been impregnated with aluminium metal to form a composite material composed of alumina fibres and aluminium. In some embodiments the sleeve member 220 may be formed by wrapping the fibres around a former in order to define the shape of the sleeve, subsequently removing the former and impregnating the fibres with aluminium metal.

The sleeve member 220 may also be referred to as an overcast or overcast member in some arrangements, since it may form an outer surface of a component when the component has been cast.

The component 200 is formed by placing the sleeve member 220 in a mould and injecting molten aluminium into the mould to fill the mould. The molten aluminium may be arranged to cause at least partial melting of the metal comprised by the sleeve member 220 in order to enable a strong bond to be formed between a cast portion 205 of the component and the sleeve member 220. Other arrangements are also useful.

FIG. 3 shows a cross-section through the A-A plane of the component 200 illustrated in FIG. 2. The component 200 comprises the sleeve member 220 and the cast portion 205 as discussed above. In some embodiments an interface 225 between the sleeve member 220 and the cast portion 205 becomes less defined than that shown in FIG 3. This occurs where the sleeve member 220 is placed in the mould prior to casting and the introduction of molten metal to the mould fills the sleeve member 220 causing at least partial melting of the inner surface 220i of the sleeve member 220. This is advantageous because the at least partially melted portion fuses with the cast portion 205 to form the component 200 which efficiently reacts bending stresses between the first mounting portion 210 and the second mounting portion 230.

In some embodiments, the sleeve member 220 may not comprise metal prior to casting. Thus, the alumina fibres that comprise the sleeve member 220 may be impregnated with aluminium when the mould in which the component is formed is filled with molten aluminium.

Embodiments of the present invention have the advantage that a component of comparable size and weight to known cast aluminium components may be formed having a substantially increased stiffness due to the employment of a sleeve member.

The sleeve member may be a blind sleeve member, for example in the form of a mitten or glove member having a single opening from which a portion of the cast portion of the component projects.

Alternatively the sleeve member may have a plurality of openings, as in the sleeve member 220 of the embodiment of FIG. 2, which has two openings formed therein. The sleeve member may be open at opposite ends thereof such as in the embodiment of FIG. 2. Other arrangements are also useful.

Embodiments of the present invention have the advantage that a given component may be formed to he of substantially increased strength and/or stiffness in a convenient manner by providing a sleeve member formed from a metal matrix composite. The sleeve member may in some embodiments be Inserted into a mould from which the component is to be formed, and a cast portion of the component cast in the mould in the conventional manner. Some embodiments of the invention allow a component to be formed of increased stiffness with relatively little disruption to a fabrication facility. In some embodiments, a mould of the type that has been used to form a component without a sleeve member may be used to form a component of the type having a sleeve member with little or no modification. In some embodiments the sleeve member may be formed such that it may simply be inserted into the mould and molten metal poured or injected into the mould in the conventional manner.

Embodiments of the present invention enable a component with improved strength and/or stiffness characteristics to be provided in a relatively convenient manner using similar materials to those previously used to form similar components, and he of comparable or substantially Identical dimensions. In some embodiments a component may be formed to have smaller dimensions from those of a comparable component not having a sleeve member, and enjoy enhanced or similar strength and/or stiffness characteristics. Other arrangements are also useful.

Throughout the description and claims of this specification, the words “comprise” and “contain” and variations of the words, for example “comprising” and “comprises”, means “including but not limited to”, and is not intended to (and does not) exclude other moieties, additives, components, integers or steps.

Throughout the description and claims of this specification, the singular encompasses the plural unless the context otherwise requires. In particular, where the indefinite article is used, the specification is to he understood as contemplating plurality as well as singularity, unless the context requires otherwise.

Features, integers, characteristics, compounds, chemical moieties or groups described in conjunction with a particular aspect, embodiment or example of the invention are to be understood to be applicable to any other aspect, embodiment or example described herein unless incompatible therewith.

1. A method of forming a component comprising:
providing a sleeve member formed from a metal matrix composite material;
casting a cast portion of the component wherein at least a portion of the cast portion is cast within the sleeve member; and
substantially filling the sleeve member with molten metal.

2. A method as claimed in claim 1 comprising casting the cast portion of the component such that the sleeve member defines at least a portion of an outer surface of the component.

3. A method as claimed in claim 1 comprising forming the component wherein the sleeve member defines a conduit through which molten metal may flow to fill the sleeve member.

4. (canceled)

5. A method as claimed in claim 1 comprising providing a blind sleeve member having a single opening for molten metal to flow therein.

6. A method as claimed in claim 1 comprising providing a sleeve member having a plurality of openings formed therein for molten metal to flow therethrough.

7. A method as claimed in claim 6 comprising causing molten metal to flow through the sleeve member to fill the sleeve member and allowing the molten metal to cool, whereby respective portions of the cast portion of the component project from the sleeve member through respective openings defined by the sleeve member.

8. A method as claimed in claim 1 wherein the step of providing a sleeve member formed from a metal matrix composite material comprises providing a sleeve member formed from an aluminium matrix composite (AMC) material.

9. A method as claimed in claim 1 wherein the cast portion is formed from a molten material comprising aluminium.

10. A method as claimed in claim 9 wherein the molten material is one selected from amongst aluminium and an aluminium alloy.

11. A method as claimed in claim 10 wherein the component is formed to be an automotive or aerospace component.

12. A method as claimed in claim 11 wherein the component is formed to be a component of a suspension system.

13. A method as claimed in claim 1 wherein the metal matrix composite material comprises alumina and at least one metal providing a matrix in which the alumina is embedded.

14. A method as claimed in claim 1 comprising placing the sleeve member in a mold; and introducing molten metal into the mold.

15. A component comprising a sleeve member, the sleeve member comprising a metal matrix composite material, the component comprising a cast portion wherein at least a portion of the cast portion is provided within the sleeve member, wherein the sleeve member is substantially filled with metal.

16. A component as claimed in claim 15 wherein the metal matrix composite material of the sleeve member comprises an aluminium matrix composite material.

17. A component as claimed in claim 15 wherein the metal matrix composite material comprises alumina and at least one metal providing a matrix in which the alumina is embedded.

18. A component as claimed in claim 15 wherein the cast portion of the component comprises one selected from amongst aluminium and an aluminium alloy.

19. A component as claimed in claim 15 wherein the component is a vehicle suspension component.

20. (canceled)

21. A motor vehicle comprising a component as claimed in claim 15.

22-23. (canceled)
